(19) United States
(12) Patent Application Publication
(10) Pub. No.: US 2026/0171282 A1
(43) Pub. Date: Jun. 18, 2026

(54) INSULATED WIRE

(71) Applicant: Proterial, Ltd., Tokyo (JP)

(72) Inventors: Yuki HONDA, Tokyo (JP); Hidetoshi Nagayama, Tokyo (JP)

(21) Appl. No.: 19/348,290

(22) Filed: Oct. 2, 2025

(30) Foreign Application Priority Data
Dec. 17, 2024 (JP) 2024-220694

(51) Int. Cl. H01B 3/30; H01B 13/06

(52) U.S. Cl. CPC H01B 3/306; H01B 13/065

(57) ABSTRACT

An insulated wire includes a conductor and an insulation film that coats the conductor. The insulation film includes polyimide and an inorganic filler. The polyimide has a biphenyl structure. A dielectric loss tangent of the insulation film at 280° C. is 0.03 or more and 0.1 or less.

### CROSS-REFERENCE TO RELATED APPLICATIONS

This application claims the benefit of Japanese Patent Application No. 2024-220694 filed on Dec. 17, 2024 with the Japan Patent Office, the entire disclosure of which is incorporated herein by reference.

### BACKGROUND

The present disclosure relates to an insulated wire.

Japanese Patent Application Publication No. 2003-036731 discloses an insulated wire. The insulated wire includes a conductor and an insulation film. The insulation film coats the conductor. An enameled wire is an example of the insulated wire. The insulated wire is used for coils in motors, transformers, and other electrical devices. The electrical devices are incorporated into hybrid vehicles, electric vehicles, and so on.

### SUMMARY

The insulation film includes laminated layers. In order to increase surge resistance of the insulation film, an inorganic filler may be added to the insulation film. In this case, a polymer component in an interface between the layers forming the insulation film may decrease. When the polymer component in the interface between the layers decreases, entanglement between molecules of the polymer component between the layers may also decrease. Consequently, adhesiveness between the layers forming the insulation film may be reduced. In one aspect of the present disclosure, it is preferable to provide an insulated wire with high adhesiveness between the layers forming the insulation film.

An insulated wire according to one aspect of the present disclosure includes a conductor and an insulation film coating the conductor. The insulation film includes polyimide and an inorganic filler. The polyimide has a biphenyl structure. A dielectric loss tangent of the insulation film at 280° C. is 0.03 or more and 0.1 or less. The insulated wire of one aspect of the present disclosure has high adhesiveness between the layers forming the insulation film.

### BRIEF DESCRIPTION OF THE DRAWINGS

An example embodiment of the present disclosure will be described hereinafter with reference to the accompanying drawings, in which:

FIG. 1 is an explanatory diagram showing a configuration of a manufacturing apparatus for a flat enameled copper wire;

FIG. 2 is a sectional view showing a cross-sectional shape of a flat copper wire;

FIG. 3 is a sectional view showing a cross-sectional shape of a flat copper drawn wire;

FIG. 4 is a sectional view showing a cross-sectional shape of the flat enameled copper wire; and

FIG. 5 is an explanatory diagram showing a method for performing a cut and stretch test.

### DETAILED DESCRIPTION OF EXEMPLARY EMBODIMENTS

### First Embodiment

### 1. Method for Manufacturing Flat Enameled Copper Wire 25

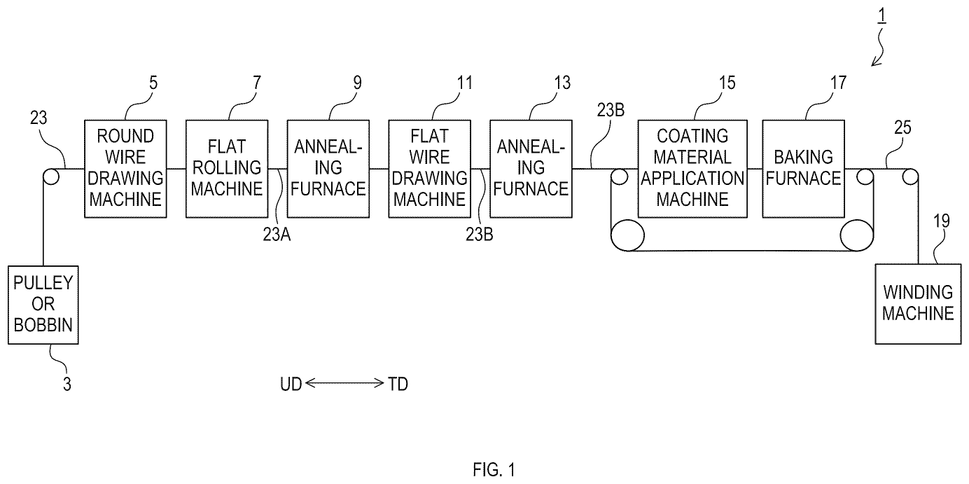

A method for manufacturing a flat enameled copper wire 25 is explained with reference to FIG. 1 to FIG. 4. The flat enameled copper wire 25 corresponds to an insulated wire. A manufacturing apparatus 1 shown in FIG. 1 is used in the method for manufacturing the flat enameled copper wire 25. The manufacturing apparatus 1 includes a pulley or bobbin 3, a round wire drawing machine 5, a flat rolling machine 7, an annealing furnace 9, a flat wire drawing machine 11, an annealing furnace 13, a coating material application machine 15, a baking furnace 17, and a winding machine 19.

A conductor 23 having a linear shape is wound around the pulley or bobbin 3. The conductor 23 is drawn out from the pulley or bobbin 3, travels along a path that passes through the round wire drawing machine 5, the flat rolling machine 7, the annealing furnace 9, the flat wire drawing machine 11, the annealing furnace 13, the coating material application machine 15, and the baking furnace 17 in this order, and is wound up by the winding machine 19. Note that a flat copper drawn wire 23B to be described below, which is the conductor 23 subjected to some processes, travels a section including the coating material application machine 15 and the baking furnace 17 multiple times.

A material for the conductor 23 is copper or a copper alloy. A cross-sectional shape of the conductor 23 is circular before flat rolling to be described below is performed. The cross section of the conductor 23 refers to a section perpendicular to a longitudinal axis of the conductor 23.

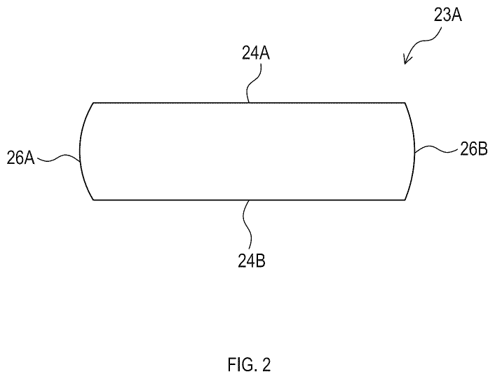

The round wire drawing machine 5 draws the conductor 23 having a circular cross-sectional shape. The flat rolling machine 7 performs the flat rolling on the conductor 23 travelling therethrough. The conductor 23 that has undergone the flat rolling is referred to as a flat copper wire 23A. As shown in FIG. 2, a cross-sectional shape of the flat copper wire 23A is a shape formed by two sides 24A and 24B parallel to each other and two arc-shaped outer edges 26A and 26B. In the cross section, each of the sides 24A and 24B has a linear shape. In the cross section, each of the sides 24A and 24B has a greater length than each of the outer edges 26A and 26B. The annealing furnace 9 anneals the flat copper wire 23A.

The flat wire drawing machine 11 performs flat wire drawing on the flat copper wire 23A travelling therethrough. The flat wire drawing is a process in which cold wire drawing is continuously performed on the flat copper wire 23A using a flat wire drawing die. The conductor 23 that has undergone the flat wire drawing is referred to as the flat copper drawn wire 23B.

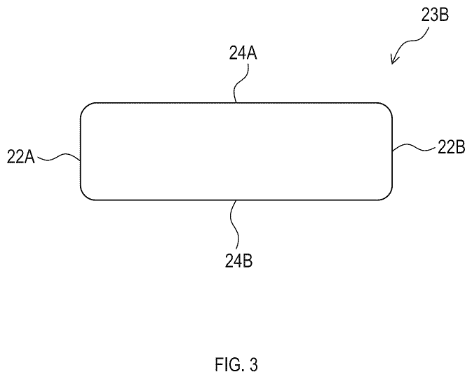

A cross-sectional shape of the flat copper drawn wire 23B is a rounded rectangle as shown in FIG. 3. Longer sides of the rounded rectangle are the sides 24A and 24B. Shorter sides 22A and 22B of the rounded rectangle are sides derived from the outer edges 26A and 26B, respectively, in the flat copper wire 23A.

As shown in FIG. 1, in the flat wire drawing machine 11, a direction in which the conductor 23 travels is referred to as a traveling direction TD. A direction opposite the traveling direction TD is referred to as an upstream direction UD. The annealing furnace 13 anneals the flat copper drawn wire 23B. The coating material application machine 15 applies an enamel coating material to a surface of the flat copper drawn wire 23B to thereby form a film of the enamel coating material of a given thickness on the surface of the flat copper drawn wire 23B.

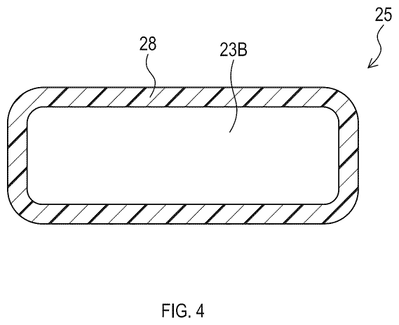

The baking furnace 17 heats and bakes the flat copper drawn wire 23B travelling therethrough, on which the film of the enamel coating material of the given thickness has been formed by the coating material application machine 15, thus forming an insulation film 28 as shown in FIG. 4. As shown in FIG. 1, the application of the enamel coating material by the coating material application machine 15 and the baking by the baking furnace 17 are repeatedly performed. The flat enameled copper wire 25 is then wound up by the winding machine 19.

The detailed method of forming the insulation film 28 is as follows. The coating material application machine 15 applies the enamel coating material to the surface of the flat copper drawn wire 23B. The enamel coating material is a coating material including a resin, a solvent, and an inorganic filler. The resin includes polyamic acid. The polyamic acid is a compound synthesized from raw materials including an acid anhydride and diamine.

Examples of the acid anhydride may include PMDA (pyromellitic dianhydride), BPDA (3,3′,4,4′-biphenyltetracarboxylic dianhydride), and TMA (trimellitic anhydride). Examples of the diamine may include ODA (4,4′-diaminodiphenyl ether) and BODA (4,4′-bis(4-aminophenoxy) biphenyl).

For example, the acid anhydride has a biphenyl structure. Examples of the acid anhydride having the biphenyl structure may include BPDA and BODA. If the acid anhydride has the biphenyl structure, the polyamic acid has the biphenyl structure. If the diamine has the biphenyl structure, the polyamic acid has the biphenyl structure. If the polyamic acid has the biphenyl structure, polyimide, which is generated from the polyamic acid, also has the biphenyl structure.

A mass ratio of a solid content in the enamel coating material is, for example, 15 mass % or more and 30 mass % or less. Examples of the inorganic filler included in the enamel coating material may include silica, alumina, and titanium oxide. For example, the surface of the inorganic filler is processed with an organic substance. In this case, the inorganic filler has excellent dispersibility in polyimide. When the enamel coating material is applied and baked, the polyamic acid changes to polyimide. The insulation film 28 thus includes the polyimide.

Since the enamel coating material includes the inorganic filler, the insulation film 28 includes the inorganic filler. Since the insulation film 28 includes the inorganic filler, the surge resistance of the insulation film 28 is improved. The amount of the inorganic filler blended in the enamel coating material and thus in the insulation film 28 is preferably 1 phr or more and 100 phr or less, more preferably 5 phr or more and 80 phr or less, and particularly preferably 10 phr or more and 50 phr or less. Phr (per hundred resin) refers to a part by mass of an additive (for example, the inorganic filler) to be blended when a resin mass is 100.

Next, the solvent in the enamel coating material applied to the surface of the flat copper drawn wire 23B is evaporated, and the enamel coating material is baked in the baking furnace 17. A single layer forming the insulation film 28 is formed after a single round of the application of the enamel coating material by the coating material application machine 15 and the baking by the baking furnace 17. By repeating the application of the enamel coating material by the coating material application machine 15 and the baking by the baking furnace 17, the insulation film 28 including laminates of multiple layers is formed.

There are an evaporation zone and a curing zone in the baking furnace 17. The flat copper drawn wire 23B, which is traveling through the baking furnace 17, passes through the evaporation zone first, and then through the curing zone. The lower the temperatures in the evaporation zone and the curing zone, the greater the value of 280° C. tan δ, which will be described later. The greater the linear velocity of the flat copper drawn wire 23B in the evaporation zone and the curing zone, the greater the value of 280° C. tan δ.

The insulation film 28 is thus formed as a result of the aforementioned processes, and accordingly, the flat enameled copper wire 25 is produced. The insulation film 28 includes the polyimide generated from the polyamic acid included in the enamel coating material. The insulation film 28 thus includes the polyimide and the inorganic filler.

### 2. Configuration of Flat Enameled Copper Wire 25

A configuration of the flat enameled copper wire 25 will be explained with reference to FIG. 4. The flat enameled copper wire 25 includes the flat copper drawn wire 23B and the insulation film 28. The flat copper drawn wire 23B corresponds to a conductor. The insulation film 28 coats the flat copper drawn wire 23B. The thickness of the insulation film 28 is, for example, 30 μm or more and 200 μm or less.

The insulation film 28 includes the polyimide and the inorganic filler. The polyimide has a biphenyl structure. The dielectric loss tangent of the insulation film 28 at 280° C. (hereinafter referred to as “280° C. tan δ”) is 0.03 or more and 0.1 or less. Preferably, 280° C. tan δ is 0.032 or more and 0.099 or less.

### 3. Effects of Flat Enameled Copper Wire 25

(1A) In the flat enameled copper wire 25, adhesiveness between the layers forming the insulation film 28 is high since 280° C. tan δ of the insulation film 28 is 0.03 or more and 0.1 or less. When 280° C. tan δ of the insulation film 28 is 0.03 or more and 0.1 or less, it is presumed that the baking of the insulation film 28 has proceeded appropriately, and thus the adhesiveness between the layers forming the insulation film 28 is high.

(1B) In the flat enameled copper wire 25, adhesiveness between the insulation film 28 and the flat copper drawn wire 23 is high.

### EXAMPLES

### 1. Manufacture of Enameled Copper Wire

Enameled copper wires of Examples 1 to 4 and Comparative Examples 1 to 9 were manufactured by the method described in the first embodiment. However, the enameled copper wires of Examples and Comparative Examples were round wires, not flat wires. Additionally, in Examples and Comparative Examples, a diameter of the conductor 23 in the coating material application machine 15 and the baking furnace 17 was 0.8 mm. Additionally, in Examples and Comparative Examples, the thickness of the insulation film 28 was 35 μm.

The methods of manufacturing the enameled copper wires of Examples and Comparative Examples were different from each other in terms of the linear velocity of the conductor in the baking furnace 17, but were identical in terms of the temperatures of the baking furnace 17 and other conditions. Raw materials and manufacturing methods for the enamel coating material were the same in Examples and Comparative Examples. Types, names, chemical names, and mole ratios of the raw materials for the enamel coating material are shown in Table 1. The solvent in the enamel coating material was DMAc (N,N-dimethylacetamide). When the enamel coating material was manufactured, a mass ratio between the raw materials and the solvent was 25:75.

TABLE 1

| | | | Mole |
|---|---|---|---|
| Raw Material | | | Ratio |
| Type | Name | Chemical Name | (mol %) |
| Acid | PMDA | pyromellitic dianhydride | 34 |
| Anhydride | BPDA | 3,3′,4,4′-biphenyltetracarboxylic | 14 |
| | | dianhydride | |
| Acid | TMA | trimellitic anhydride | 2 |
| Anhydride | | | |
| Diamine | ODA | 4,4′-diaminodiphenyl ether | 43 |
| | BODA | 4,4′-bis(4-aminophenoxy)biphenyl | 7 |

The enamel coating material was manufactured as described below. ODA, BODA, and DMAc were put into a flask. Next, ODA and BODA were mixed by stirring with a stirrer until they were completely dissolved, thereby yielding a reaction solution. Next, while stirring the reaction solution, PMDA and BPDA were added. After the dissolution of PMDA and BPDA, TMA was added and stirring was continued.

Next, silica sol was added so that an amount of added filler was 25 phr, and then stirring was performed. Next, dilution was performed with DMAc. The enamel coating material was obtained through the above-described processes.

In Example and Comparative Examples, the temperatures of the baking furnace 17 and the linear velocity of the conductor in the baking furnace 17 were as shown in Table 2. Table 2 shows temperature of the evaporation zone and temperature of the curing zone as the temperature of the baking furnace 17.

TABLE 2

| | Temperature | | | | |
|---|---|---|---|---|---|
| | at Evapora- | Temperature | Linear | | Length |
| | tion | at Curing | Velocity | 280° C. | (L) |
| | Zone (° C.) | Zone (° C.) | (m/mm) | tan δ | (mm) |
| Example 1 | 400 | 500 | 30 | 0.0323 | 0.1 |
| Example 2 | 400 | 500 | 35 | 0.043 | 0 |
| Example 3 | 400 | 500 | 40 | 0.0842 | 0.64 |
| Example 4 | 400 | 500 | 45 | 0.0982 | 0.74 |
| Comperative | 400 | 500 | 12.5 | 0.0261 | 240 |
| Example 1 | | | | | |
| Comperative | 400 | 500 | 13.75 | 0.0244 | 240 |
| Example 2 | | | | | |
| Comperative | 400 | 500 | 15 | 0.0268 | 240 |
| Example 3 | | | | | |
| Comperative | 400 | 500 | 16.25 | 0.0229 | 216 |
| Example 4 | | | | | |
| Comperative | 400 | 500 | 17.5 | 0.0202 | 99.8 |
| Example 5 | | | | | |
| Comperative | 400 | 500 | 20 | 0.0231 | 30.1 |
| Example 6 | | | | | |
| Comperative | 400 | 500 | 25 | 0.0241 | 1.2 |
| Example 7 | | | | | |
| Comperative | 400 | 500 | 50 | 0.116 | 2.14 |
| Example 8 | | | | | |
| Comperative | 400 | 500 | 55 | 0.1684 | 2.64 |
| Example 9 | | | | | |

### 2. Measurement of 280° C. Tan δ

280° C. tan δ was measured for each Example and each Comparative Example. The measurement method was as follows.

280° C. tan δ was measured using an LCR meter 4263B manufactured by TOTOKU TORYO CO., LTD. The enameled copper wire having a length of 40 mm was prepared. Of this enameled copper wire, the insulation film 28 was peeled off 10 mm from ends of the enameled copper wire. After the insulation film 28 was peeled off, the enameled copper wire was used as a measurement sample. Next, the measurement sample was placed in a metal bath and connected to electrode clips at separate end portions of the measurement sample. The separate end portions are portions where the insulation film 28 was peeled off. In this state, the metal bath was heated up while measuring a dielectric loss tangent at a measurement frequency of 1 kHz, thereby measuring a dielectric loss tangent when a temperature of the metal bath reached 280° C. (in other words, 280° C. tan δ). The measurement results are shown in Table 2.

### 3. Cut and Stretch Test

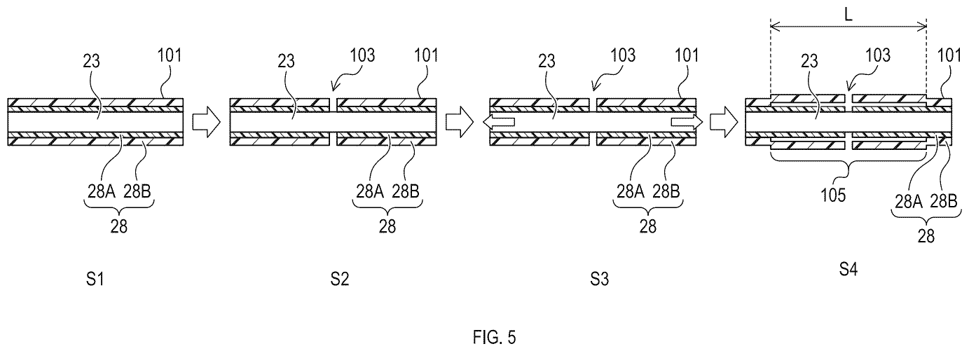

A cut and stretch test was performed for Examples and Comparative Examples. The cut and stretch test evaluates adhesiveness between the layers forming the insulation film 28. First, a measurement sample 101 was prepared as shown in S1 in FIG. 5. The measurement sample 101 was an enameled copper wire cut to a length of 200 mm. A cut surface was a cross section of the enameled copper wire.

Subsequently, a cut 103 was formed in the measurement sample 101 as shown in S2 in FIG. 5. The cut 103 was positioned at the center of the measurement sample 101 in its longitudinal direction. The cut 103 extends in a circumferential direction of the measurement sample 101 along the entire circumference of the measurement sample 101. The cut 103 went from the surface of the insulation film 28 to the surface of the conductor 23. Next, as shown in S3, the measurement sample 101 was extended 20% in its longitudinal direction.

After the cut 103 was formed, a separation area 105 resulted around the cut 103 as shown in S4 in FIG. 5. The separation area 105 refers to an area where an inner layer 28A of the insulation film 28 and an outer layer 28B of the insulation film 28 are delaminated from each other, or an area where the conductor 23 and the inner layer 28A of the insulation film 28 are separated from each other. The separation area 105 is visually recognizable from outside the measurement sample 101. The length L of the peel-off area 105 was measured. The length L was the length in the longitudinal directions of the measurement sample 101. The results of the measurement of the length L are shown in Table 2.

The length L was short in Examples 1 to 4 but was long in Comparative Examples 1 to 9. The shorter the length L, the higher the adhesiveness between the layers forming the insulation film 28. Thus, the adhesiveness between the layers forming the insulation film 28 was high in Examples 1 to 4 but was low in Comparative Examples 1 to 9.

### OTHER EMBODIMENTS

Although the embodiment of the present disclosure has been explained above, the present disclosure can be implemented in various modifications, without being limited to the aforementioned embodiment.

(1) The insulated wire may be any insulated wire other than an enameled wire.

(2) Among the layers forming the insulation film 28, at least one layer situated on a conductor 23 side may be an adhesion layer that includes the polyimide but does not include the inorganic filler. The polyimide included in the adhesion layer has a biphenyl structure, for example. By applying the enamel coating material not including the inorganic filler, the adhesion layer can be formed.

The adhesion layer is a layer in contact with the conductor 23. The layers on an outer peripheral side relative to the adhesion layer/layers are surge resistant layers that include the polyimide and the inorganic filler. In this case, the insulated wire of the present disclosure can increase the adhesiveness between the adhesion layer and the surge resistant layers. In addition, the insulated wire of the present disclosure can increase the adhesiveness between the surge resistant layers. Since the adhesion layer does not include the inorganic filler, the adhesiveness between the conductor 23 and the adhesion layer is high.

For example, the insulation film 28 has fourteen layers. Of these layers, one to seven layers are the adhesion layers and seven to thirteen layers are the surge resistant layers. Or, the insulation film 28 has forty layers. Of these layers, one to twenty layers are the adhesion layers and twenty to thirty-nine layers are the surge resistant layers.

(3) Among the layers forming the insulation film 28, at least part of layers not in contact with the conductor 23 may be a layer/layers that include the polyimide but do not include the inorganic filler.

For example, among the layers forming the insulation film 28, at least one layer situated on the conductor 23 side is a surge resistant layer that includes the polyimide and the inorganic filler. A layer/layers on the outer peripheral side relative to the surge resistant layer/layers is/are a layer/layers that include the polyimide but do not include the inorganic filler.

For example, the insulation film 28 has fourteen layers. Of these layers, one to seven layers are the surge resistant layers and seven to thirteen layers are the layers that include the polyimide but do not include the inorganic filler. Or, the insulation film 28 has forty layers. Of these layers, one to twenty layers are the surge resistant layers and twenty to thirty-nine layers are the layers that include the polyimide but do not include the inorganic filler.

(4) Functions of one element in each of the aforementioned embodiments may be distributed to two or more elements; and functions of two or more elements in each of the aforementioned embodiments may be performed by one element. A part of the configurations of the aforementioned embodiments may be omitted. At least a part of the configurations of each of the aforementioned embodiments may be added to or replaced with configurations of the aforementioned other embodiments.

(5) In addition to the insulated wire as described above, the present disclosure can be realized in various forms such as a product including the insulated wire as an element, a method for manufacturing the insulated wire, and the like.

What is claimed is:

1. An insulated wire, comprising:
a conductor; and
an insulation film coating the conductor,
the insulation film including polyimide and an inorganic filler,
the polyimide having a biphenyl structure, and
a dielectric loss tangent of the insulation film at 280° C. being 0.03 or more and 0.1 or less.

2. The insulated wire according to claim 1,
wherein, among layers forming the insulation film, a layer in contact with the conductor includes the polyimide but does not include the inorganic filler.

3. The insulated wire according to claim 1,
wherein, among layers forming the insulation film, at least part of layers not in contact with the conductor includes a layer that includes the polyimide but does not include the inorganic filler.

4. The insulated wire according to claim 2,
wherein the layer in contact with the conductor includes the polyimide having a biphenyl structure.
